(19) United States
(12) Patent Application Publication
(10) Pub. No.: US 2006/0050334 A1
(43) Pub. Date: Mar. 9, 2006

(54) Diagnostic tool with data modem test

(76) Inventors: David G. Hille, Bush Prairie, WA (US); Kenneth L. Buswell, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/260,533

(22) Filed: Oct. 26, 2005

Related U.S. Application Data
(63) Continuation-in-part of application No. 10/774,030, filed on Feb. 5, 2004.

(51) Int. Cl. H04N 1/46

(52) U.S. Cl. 358/504

(57) ABSTRACT

A diagnostic tool includes a telephone connector, a phone line emulator and a processor. The phone line emulator emulates a telephone connection to a device under test connected to the telephone connector. The processor allows a user to select tests to be performed on the device under test. The tests include a send fax test, a receive fax test and a data modem test.

CROSS REFERENCE TO RELATED APPLICATION

This application is a continuation-in-part of application Ser. No. 10/774,030, filed Feb. 5, 2005.

### BACKGROUND

Stores receive millions of dollars of returns of products. Sometimes the returns result from defective products. Other times the returns result from customer dissatisfaction with a product despite no product defect. If a product is defective, the product is generally returned to the manufacturer. If the product is not defective, it is advantageous to both the stores and the manufacturer if the product can be resold without returning the product to the manufacturer.

Before reselling a returned product, it is desirable that a store be able to test the product to assure proper operation. For example, Hewlett-Packard Company provides a diagnostic tool to stores that allow stores to perform tests to aid in the determination of whether returned printers are faulty.

Laptop and desktop personal computers (PCs) are typically equipped with data and fax modems. Currently available diagnostic tools do not include the capability to perform field-testing for correct operation of fax/data modem functionality of a personal computer.

### SUMMARY OF THE INVENTION

In accordance with an embodiment of the present invention, a diagnostic tool includes a telephone connector, a phone line emulator and a processor. The phone line emulator emulates a telephone connection to a device under test connected to the telephone connector. The processor allows a user to select tests to be performed on the device under test. The tests include a send fax test, a receive fax test and a data modem test.

### BRIEF DESCRIPTION OF THE DRAWINGS

FIG. 1 and FIG. 2 are simplified diagrams of a handheld diagnostic tool that performs data and fax modem testing of a personal computer in accordance with an embodiment of the present invention.

FIG. 3 is a simplified block diagram of the handheld diagnostic tool shown in FIG. 1 in accordance with an embodiment of the present invention.

FIG. 4, FIG. 5, FIG. 6, FIG. 7, FIG. 8, FIG. 9 and FIG. 11 show example simplified screens displayed on a display of the handheld diagnostic tool shown in FIG. 1 in accordance with an embodiment of the present invention.

FIG. 10 is a simplified flow chart that illustrates data modem testing by the handheld diagnostic tool shown in FIG. 1 in accordance with an embodiment of the present invention.

FIG. 12 is a simplified flow chart that illustrates sending a fax by the handheld diagnostic tool shown in FIG. 1 in accordance with an embodiment of the present invention.

FIG. 13 is a simplified flow chart that illustrates receiving a fax by the handheld diagnostic tool shown in FIG. 1 in accordance with an embodiment of the present invention.

FIG. 14 is a simplified flow chart that illustrates a full fax test performed by the handheld diagnostic tool shown in FIG. 1 in accordance with an embodiment of the present invention.

### DESCRIPTION OF THE EMBODIMENT

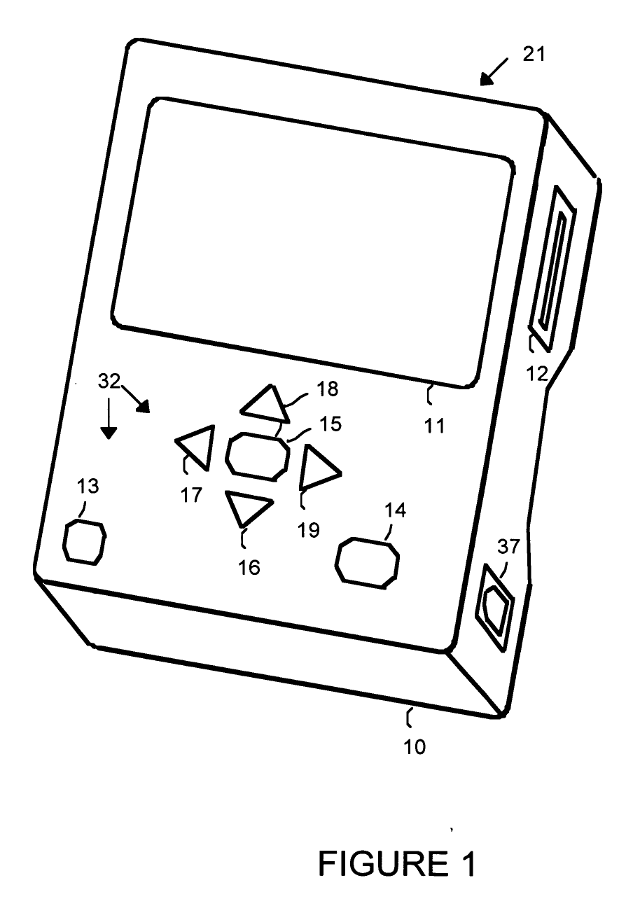

FIG. 1 shows a simplified diagram of a diagnostic tool 10 that is used to test a device under test (DUT). The diagnostic tool 10 includes a display 11, a USB slave connector 37, and another connector 12. Diagnostic tool 10 also can also include, for example, additional connectors and can include the ability to perform wireless communication. For example, display 11 is a liquid crystal display (LCD). A keypad 32 for diagnostic tool 10 includes, for example, a power key 13, a menu key 14, a selection key 15, a direction key 16, a direction key 17, a direction key 18 and a direction key 19.

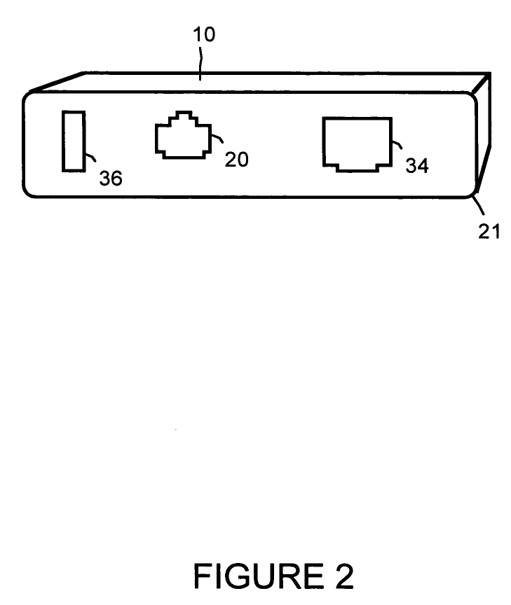

A top region 21 of diagnostic tool 10 contains additional connectors. For example, as shown in FIG. 2, top region 21 of diagnostic tool 10 contains a USB host connector 36, an RJ-45 Ethernet connector 34 and a telephone line connector 20. The telephone line connector may be for analog ISDN, digital proprietary protocols or IP protocol transmissions.

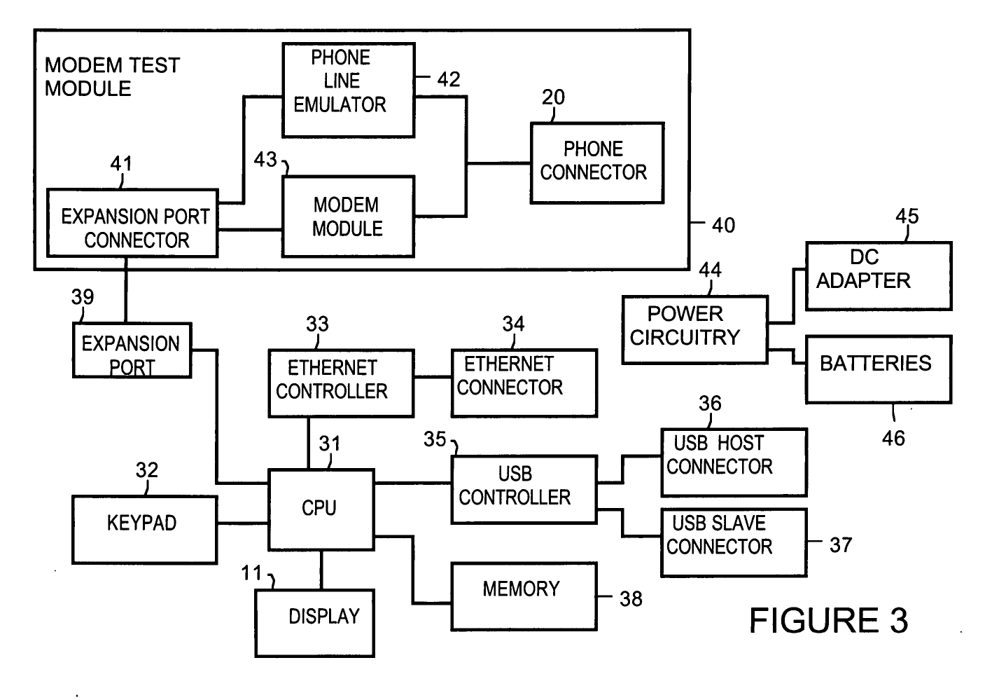

FIG. 3 shows a simplified block diagram for diagnostic tool 10. A central processing unit (CPU) 31 interfaces with keypad 32, an Ethernet controller 33, a universal serial bus (USB) controller 35, memory 38, display 11 and an expansion port 39. Ethernet controller 33 controls communication over Ethernet connector 34. USB controller 35 controls communication over USB host connector 36 and USB slave connector 37.

An expansion port connector 41 within a modem test module 40 is connected to an expansion port 39. Modem test module 40 also includes a phone line emulator 42, a modem module 43 and phone connector 20. Phone line emulator 42 provides emulation of a phone line including a disconnect message (an on-hook signal), a connection signal (an off-hook signal) and an alerting message (ring signal). Modem module 43 provides the capability to communicate with both a data modem and a fax modem.

For example, in one embodiment, phone line emulator 42 is implemented using a Subscriber Line Interface Circuit (SLIC). Normally, a SLIC is used to provide a Plain Old Telephone System (POTS), converting the digital infrastructure of a modem phone company to the analog interface commonly used by most phones. The SLIC provides necessary functionality of a phone line emulator, such as proper line voltages, ring capability, etc. The SLIC also provides the additionally advantage of being very small and consumes minimal power so that it can be easily integrated into a small portable test tool. Alternatively, as will be understood by persons of ordinary skill in the art, phone line emulator 42 can be implemented using other devices that provide telephone line emulation functionality.

The connection between expansion port 39 and expansion port connector 41 provides both power and control to phone line emulator 42 and modem module 43. Connector 20 is used to connect to a telephone connector of a device under test (DUT) that includes fax capability, includes data modem connectivity or includes both fax capability and data modem connectivity. CPU 31 executes programming instructions within memory 38 to control operation of diagnostic tool 10. CPU 31 allows a user to select tests, such as a send fax test, a receive fax test and a data modem test, to be performed on a DUT.

A user can use keypad 32 to access and interact with menus displayed on display 11. Power circuitry 44 provides power to the components of diagnostic tool 10. Power is supplied to power circuitry 44, for example, by a DC adapter 45 or by batteries 46. For example, batteries 46 consist of four AA batteries. Power circuitry 44 generates, for example, a five-volt power signal and a 3.3-volt power signal.

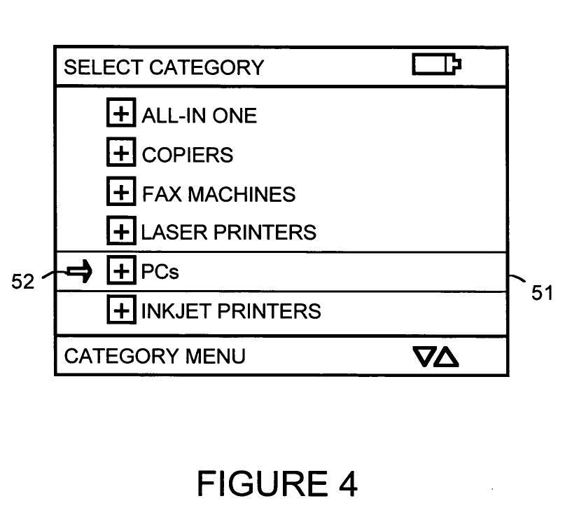

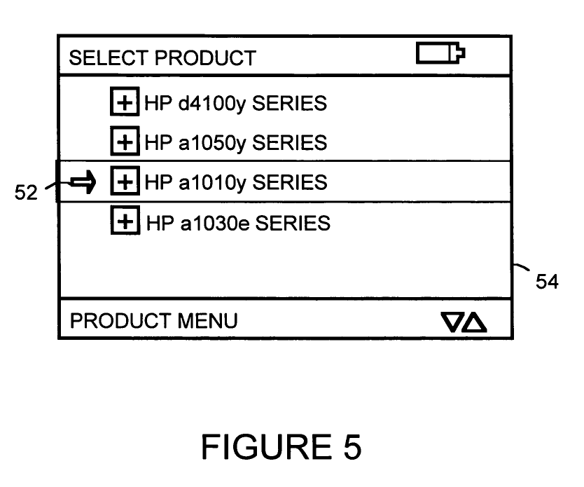

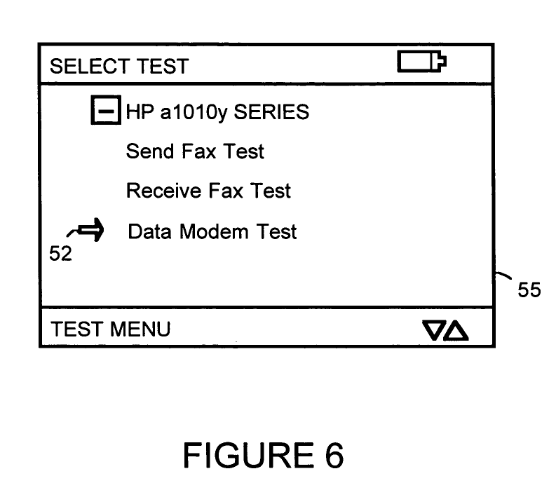

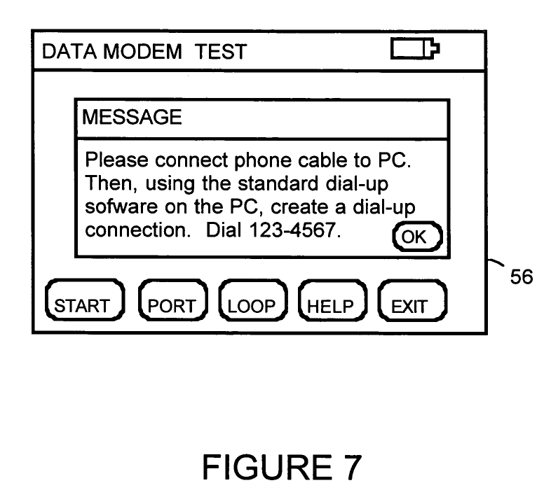

FIG. 4 shows a select category menu 51 as displayed on display 11. A user can use select category menu 51 to select a product category on which to perform tests. Some devices in some categories have fax capability while other devices do not have fax capability. Location of a cursor 52 on select category menu 51 is controlled using direction key 16 and direction key 18 (shown in FIG. 1). In FIG. 4, “PCs” is highlighted and can be selected by the user pressing selection key 15 (shown in FIG. 1).

FIG. 5 shows a select product menu 54 as displayed on display 11. The user can use select product menu 54 to select a product on which to perform tests. Location of cursor 52 on select product menu 54 is controlled using direction key 16 and direction key 18 (shown in FIG. 1). In FIG. 5, “HP a1010y series” is highlighted and can be selected by the user pressing selection key 15 (shown in FIG. 1).

FIG. 6 shows a select test menu 55 as displayed on display 11. The user can use select test menu 55 to select a test to be performed. Alternatively, multiple tests can be selected for sequential operation. Location of cursor 52 on select test menu 55 is controlled using direction key 16 and direction key 18 (shown in FIG. 1). In FIG. 6, “data modem test” is highlighted and can be selected by the user pressing selection key 15 (shown in FIG. 1).

FIG. 7 shows a data modem test menu 56 as displayed on display 11 that includes a message instructing the user to connect a phone cable to the PC and to create a dial-up connection.

FIG. 8 shows a data modem test menu 57 as displayed on display 11 when a data modem test is performed. The graphics give the user feedback on the progress of the data modem test.

FIG. 9 shows a data modem test menu 58 as displayed on display 11 that includes a message instructing the user to use a web browser in order to very that a “connection OK” message appears on a particular web page.

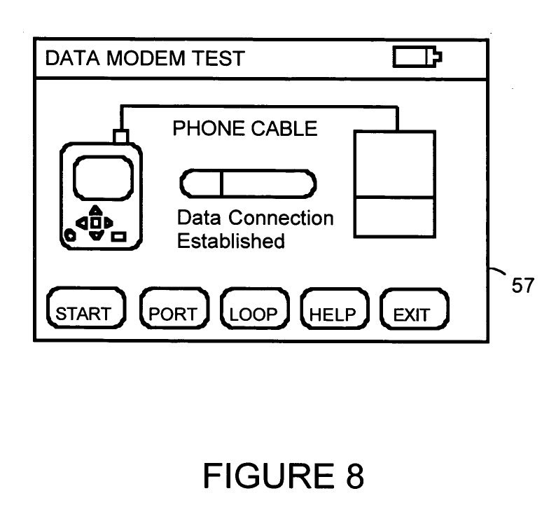

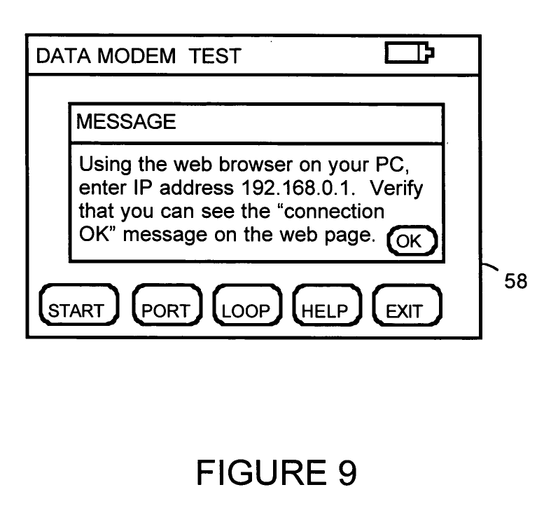

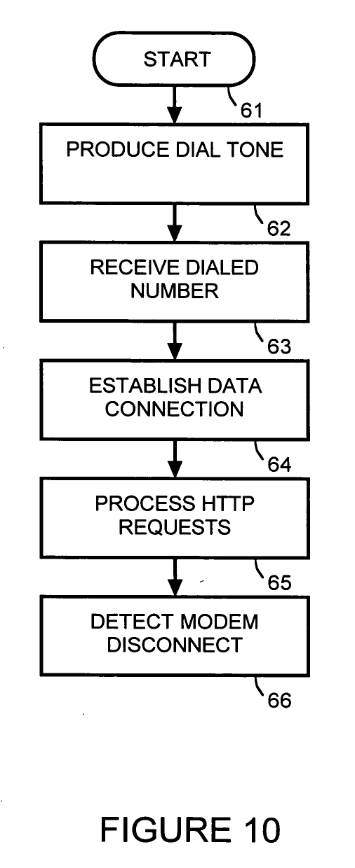

FIG. 10 is a simplified flow chart that illustrates functions performed by diagnostic tool 10 when performing a data modem test. In a block 61, the test is started. In a block 62, diagnostic tool 10 produces a dial tone. In a block 63, diagnostic tool 10 receives a dialed number. In a block 64, diagnostic tool 10 establishes a data connection. In a block 65, diagnostic tool 10 processes hypertext transfer protocol (HTTP) requests. In a block 66, diagnostic tool 10 detects a modem disconnection.

When select test menu 55, shown in FIG. 6, is used to select “Send Fax Test” or “Receive Fax Test”, the fax capability of a PC data/fax modem can be tested.

For example, FIG. 11 shows a send fax menu 59 as displayed on display 11 when a send fax test is performed. The graphics give the user feedback on the progress of the send fax test.

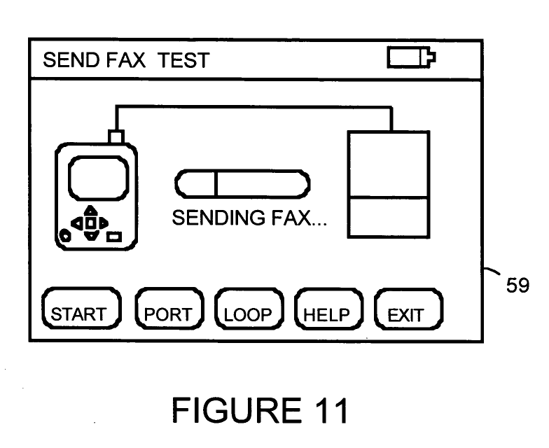

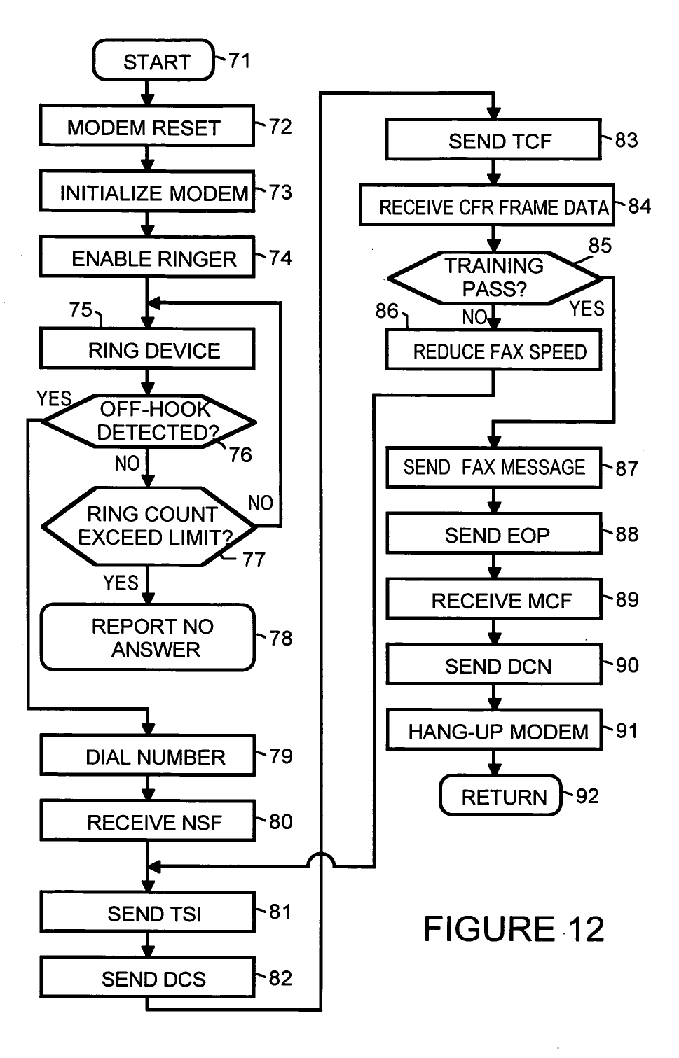

FIG. 12 is a simplified flow chart that illustrates functions performed by diagnostic tool 10 when performing a send fax test via an analog telephone line. The use of an analog telephone line is exemplary and provides enough information for a person of ordinary skill in the art to perform a send fax test with other types of telecommunications connections and protocols. In a block 71, the test starts as the result of a user selection. In a block 72, the modem within modem module 43 (shown in FIG. 3) is reset. In a block 73, the modem is initialized. In a block 74, a ringer within phone line emulator 42 (shown in FIG. 3) is enabled. In a block 75, phone line emulator 42 produces a ring signal sent through phone connector 20 to the DUT.

In a block 76, a check is made to determine whether an off-hook is detected indicating the DUT has answered the call. If no off-hook is detected, in a block 77 a check is made to see if a ring count exceeds a ring count limit. If the ring count exceeds the ring count limit, in a block 78, “no answer” is reported back to the user through a message on display 11 (shown in FIG. 1).

If in block 77, the ring count does not exceed the ring count limit, the process returns to block 75 where phone line emulator 42 produces a ring signal sent through phone connector 20 to the DUT.

If in block 76, off-hook is detected, in block 79, a number is dialed. The number is dialed at this point because when the DUT receives the rings, the DUT goes “off-hook”. Diagnostic tool 10 “sees” the “off-hook” condition and sends an ATD command to modem module 43. The ATD (Attention Dial the phone) command causes modem module 43 to attempt to establish a connection by first producing the auto fax tone (CNG). The DUT needs to see the CNG to know that a Fax device is on the other end of the line.

In a block 80, non-standard facilities (NSF) frame data is received from the DUT. In a block 81, modem training is started by sending a transmitting subscriber identifier (TSI) to the DUT. In a block 82, a digital command signal (DCS) is sent to the DUT. In a block 83, a training check frame (TCF) is sent to the DUT. In a block 84, confirmation to receive frame (CFR) frame data is received from the DUT. In a block 85, diagnostic tool 10 checks to see if training is passed. If training is not passed, in a block 86, fax speed is reduced. Then, diagnostic tool 10 returns to block 81 to restart modem training by sending a transmitting subscriber identifier (TSI) to the DUT.

If in block 85, training is passed, in a block 87, a fax message is sent from diagnostic tool 10 to the DUT. In a block 88, an end of procedure (EOP) is sent by diagnostic tool 10 to the DUT. In a block 89, a message confirmation frame (MCF) is received by diagnostic tool 10. If the MCF is not received, diagnostic tool 10 generates an error message. In a block 90, diagnostic tool 10 sends a disconnect frame (DCN) to the DUT. In a block 91, diagnostic tool 10 hangs up the modem. In a block 92, the send fax test is complete.

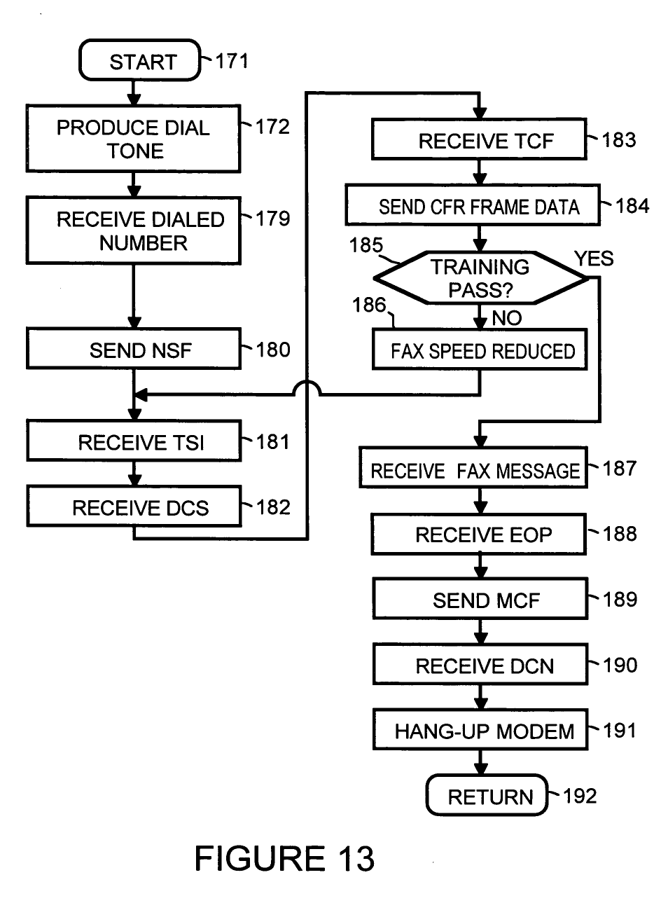

FIG. 13 is a simplified flow chart that illustrates functions performed by diagnostic tool 10 during a receive fax test. In a block 171, the process starts as the result of a user selection. In a block 172, phone line emulator 42 (shown in FIG. 3) produces a dial tone. In a block 179, diagnostic tool 10 receives a dialed number from the DUT. Diagnostic tool, for example, verifies dual tone multi-frequency (DTMF) tones produced by the DUT when the DUT dials the number. In a block 180, diagnostic tool 10 sends a non-standard facilities (NSF) frame data to the DUT. In a block 181, modem training is started by receiving a transmitting subscriber identifier (TSI) from the DUT. In a block 182, a digital command signal (DCS) is sent by the DUT and received by diagnostic tool 10. In a block 183, a training check frame (TCF) from the DUT is received by diagnostic tool 10. In a block 184, diagnostic tool 10 sends a confirmation to receive frame (CFR) frame data to the DUT. In a block 185, a check by the DUT is made to see if training is passed. If training is not passed, in a block 186, the DUT reduces the fax speed. Then, in block 181, modem training is restarted and diagnostic tool receives another transmitting subscriber identifier (TSI) from the DUT.

If in block 185, training is passed, in a block 187 a fax message is sent by the DUT and received by diagnostic tool 10. If the fax message is not received by diagnostic tool 10, diagnostic tool 10 generates an error message. In a block 188, an end of procedure (EOP) is sent by the DUT and received by diagnostic tool 10. If the EOP is not received by diagnostic tool 10, diagnostic tool 10 generates an error message. In a block 189 a message confirmation frame (MCF) is sent by diagnostic tool 10 to the DUT. In a block 190, diagnostic tool 10 receives a disconnect frame (DCN) from the DUT. If the DCN is not received by diagnostic tool 10, diagnostic tool 10 generates an error message. In a block 191, diagnostic tool 10 hangs up the modem. In a block 192, the receive fax test is complete.

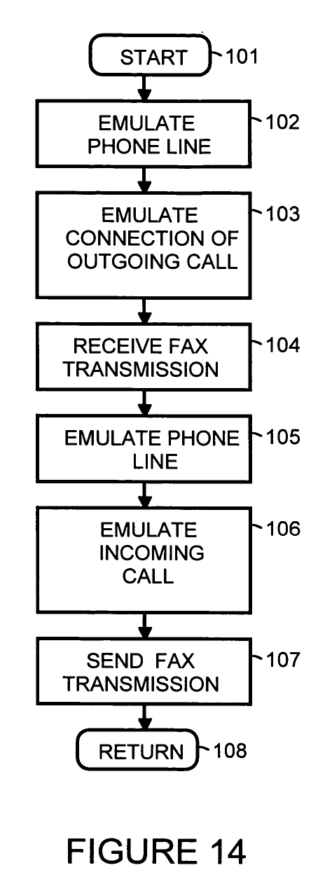

FIG. 14 is a simplified flowchart of a complete fax test. In a block 101, the fax test is started. In a block 102, diagnostic tool 10 emulates a phone line to the DUT. In a block 103, diagnostic tool 10 emulates connection of an outgoing call from the DUT. In a block 104, diagnostic tool 10 receives a fax transmission from the DUT. The contents of the fax transmission are stored in memory 38 (shown in FIG. 3) within diagnostic tool 10. In a block 105, diagnostic tool 10 then emulates to the DUT an idle phone line. In a block 106, diagnostic tool 10 emulates to the DUT an incoming call. In a block 107, diagnostic tool 107 sends a fax transmission to the DUT. The fax transmission includes the contents of the fax transmission that is stored in memory 38. In a block 108, the complete fax test is finished. The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A diagnostic tool, comprising:
a telephone connector;
a phone line emulator that emulates a telephone connection to a device under test connected to the telephone connector; and,
a processor that allows a user to select tests to be performed on the device under test, the tests including:
a send fax test,
a receive fax test, and
a data modem test.

2. A diagnostic tool as in claim 1, additionally comprising a display that displays menus that allow a user to make selections, the menus including a select test menu and a select product menu.

3. A diagnostic tool as in claim 1, additionally comprising a display that displays menus that allow a user to make selections, the menus including a select category menu, a select product menu and a select test menu.

4. A diagnostic tool as in claim 1, additionally comprising:
power circuitry based on power supplied by battery.

5. A diagnostic tool as in claim 1 additionally comprising a display that displays menus that allow a user to make selections, wherein the menus list devices that can be tested by the diagnostic tool.

6. A diagnostic tool as in claim 1 wherein the diagnostic tool is a portable handheld diagnostic tool.

7. A method by which a diagnostic tool performs a test on a device under test, the method comprising:
displaying by the diagnostic tool, a plurality of tests, the tests including the following:
a data modem test,
a send fax test, and
a receive fax test;
receiving by the diagnostic tool a user selection of a test, from the plurality of tests, to be performed; and,
performing the test by the diagnostic tool, including the following:
establishing communication contact with a modem within a device under test,
emulating a phone line, and
performing the test selected by the user.

8. A method as in claim 7 wherein the method additionally includes:
displaying by the diagnostic tool a select product menu.

9. A method as in claim 7 wherein the method additionally includes:
displaying by the diagnostic tool a select category menu and a select product menu.

10. A method as in claim 7, additionally comprising:
supplying power to the diagnostic tool via a battery.

11. A method as in claim 7 wherein the method additionally includes:
listing, by the diagnostic tool, devices that can be tested by the diagnostic tool.

12. A diagnostic tool comprising:
means for providing a telephone connection to a modem within a device under test, including means for emulating a phone line;
means for displaying menus to a user; and,
means for controlling display of the menus by the display means, the menus allowing the user to select tests to be performed on a device under test, the tests including:
a data modem test,
a send fax test, and
a receive fax test.

13. A diagnostic tool as in claim 12 wherein
the menus include a select test menu and a select product menu.

14. A diagnostic tool as in claim 12 wherein
the menus include a select category menu, a select product menu and a select test menu.

15. A diagnostic tool as in claim 12, additionally comprising:
power circuitry based on power supplied by battery.

16. A diagnostic tool as in claim 12 wherein
wherein the menus list devices that can be tested by the diagnostic tool.

17. A diagnostic tool as in claim 12 wherein the diagnostic tool is a portable handheld diagnostic tool.

18. A modem test module within a diagnostic tool, the modem test module comprising:
a telephone connector,
a phone line emulator that emulates a telephone connection to a device under test connected to the telephone connector;
wherein in response to a user indicating a selected test to the diagnostic tool, the selected test being one of a send fax test, a receive fax test, and a data modem test, the diagnostic tool utilizes the modem test module to perform the selected test.

19. A modem test module as in claim 18, wherein the modem test module is powered by power circuitry based on power supplied by battery.

20. A modem test module as in claim 18 wherein the diagnostic tool is a portable handheld diagnostic tool.
